(19) United States
(12) Patent Application Publication
(10) Pub. No.: US 2007/0007691 A1
(43) Pub. Date: Jan. 11, 2007

(54) Injection molding method and apparatus, and molded products manufactured thereby

(76) Inventors: Sami Sagol, Ramat Hasharon (IL); Alexander Shusier, Migdal HaEmek (IL)

Correspondence Address: Gary M. Nath;NATH & ASSOCIATES PLLC, 112 South West Street, Alexandria, VA, 22314, US

(21) Appl. No.: 11/443,453

(22) Filed: May 31, 2006

Related U.S. Application Data
(63) Continuation-in-part of application No. 10/746,437, filed on Dec. 24, 2003.

(51) Int. Cl. B29C 45/14

(52) U.S. Cl. 264/259; 425/149; 425/150

(57) ABSTRACT

A method, apparatus and system are provided for producing a molded part having a visually exposed surface comprising at least one side surface, the or each side surface being joined to a base surface at a corresponding substantially rectilinear edge. According to one aspect of the invention, the method includes the steps of: providing a mold comprising a mold surface complementary to said visually exposed surface; providing a film comprising a first face and a second face, and inserting said film into said mold such that said first face is facing said mold surface; closing the mold and injecting a molten material into the mold in a manner to urge said first face of said film into abutting contact with said mold surface and such that at least a layer of said molten material is formed in overlying relationship with said second face of said film; and allowing the molten material to solidify and possess said film.

### FIELD OF THE INVENTION

This invention relates to methods and apparatuses for making a part. More particularly, the present invention relates to methods and apparatuses for making a part by injection molding and to molded parts or products made thereby.

### BACKGROUND OF THE INVENTION

Images are often applied to surfaces of a part, such as, but not limited to, a table top, a cabinet door, or the like, to enhance the appearance of the part, but require a multi-step process. This multi-step process includes producing the part and then subsequent thereto applying the images to the already produced part.

Thus, there exists a need for a method and apparatus to reduce processing steps and costs for enhancing the appearance of an injection molded part by having film applied during the injection molding process that covers visually-exposed face and side surfaces of the part and the edge of the part formed where the visually-exposed face and side surfaces of the part meet, in their entireties.

Numerous innovations for injected molded related devices have been provided in the prior art. Even though these innovations may be suitable for the specific individual purposes to which they address, they each differ in structure and/or operation and/or purpose from the present invention.

FOR EXAMPLE, U.S. Patent Application Publication Number U.S. 2003/0122278 A1 to Kosanvoich teaches a method for applying multiple decorative sheets of film to an injection-mold component as a part of the injection mold process. Two sheets of film having desired images are permanently affixed to the surfaces of the injection mold component as a part of the injection molding process. An enhanced three-dimensional appearance is achieved by affixing the images to a transparent injection mold component.

ANOTHER EXAMPLE, U.S. Pat. No. 4,052,497 to Monnet teaches a method for the manufacture by injection molding of articles composed of a plurality of layers of at least three distinct materials coated one over the other. The method includes the steps of successive injection of a measured quantity of a first material adapted to form the skin of the article, a measured quantity of a second material to form the intermediate layer, and a measured quantity of a third material to form the body of the article. The materials are introduced into the mold coaxially so as to give a uniform distribution. The method is especially applicable to the production of articles in which the external and internal materials are joined together by an intermediate material.

STILL ANOTHER EXAMPLE, U.S. Pat. No. 4,686,076 to Dromigny et al. teaches a method, machine, and mold for fabricating, by injection of synthetic material, containers having a film forming an external coating. The machine includes a mold, an injection nozzle, a film feed device, and apparatus for holding the film against the male element of the mold. The injection nozzle is carried by the male element of the mold and the holding apparatus includes a slider in the cavity of the female element movable, under the action of the male element, against a return force.

YET ANOTHER EXAMPLE, U.S. Pat. No. 5,240,751 to Cakmakei teaches a decorative automotive vehicle trim strip and method and apparatus for forming by reshaping an end of a previously extruded length of thermoplastic material. The surface of the length of the thermoplastic material intended for viewing is maintained at a cold temperature, well below the softening point of the thermoplastic material, during the reshaping operation. The length of the thermoplastic material is heated during reshaping by a mold section heated to 400 degrees F. to 410 degrees F. pressed against the surface intended to be affixed to the vehicle.

STILL YET ANOTHER EXAMPLE, U.S. Pat. No. 5,415,536 to Ohno teaches a method for forming a pattern onto an article during injection molding thereof. A pattern-bearing film is heated and softened by a heating board. The softened pattern-bearing film is transferred to the cavity surface of a female mold. Thereafter, the female mold and a male mold are closed. Then, a molten resin is injected into the cavity. When the pattern-bearing film is brought into contact with and heated by the heating board, marks or impressions of air blow holes on the surface of the heating board remain on the pattern-bearing film. To prevent the formation of these marks or impressions, a square-shaped holding frame is fixed on the surface of the heating board. The peripheral portion of the pattern-bearing film is held on the surface of the holding frame. Thus, while the pattern portion of the pattern-bearing film is spaced apart from the surface of the heating board, the film is heated. To keep the pattern-bearing film uniformly spaced from the surface of the heating board, air is supplied to the inside of the holding frame.

YET STILL ANOTHER EXAMPLE, U.S. Pat. No. 6,090,336 to Hirmer et al. teaches a method and apparatus for manufacturing an injection-molded article having an outer film on an exposed surface. The method includes securing the film about its periphery within a mold cavity prior to injection of molten material into the cavity. One way of securing the film is by applying vacuum pressure through peripheral holes in a frame surrounding the mold cavity. Molten material is injected into the cavity behind the film, and the film slips from its initial position to be forced against a wall of the cavity by molten material being injected into the cavity. The apparatus includes a frame for a molding apparatus adapted to initially secure the film in place prior to movement of the core block into place and to permit the film to slip from its initial position to be forced against the cavity wall as molten material fills the cavity.

STILL YET ANOTHER EXAMPLE, U.S. Pat. No. 6,474,976 to Oami et al. teaches a film holding apparatus for an injection mold which is capable of surely holding a protective film on a specific position of a mold surface of the injection mold. The film holding apparatus for holding an inner film on the mold surface of the injection molds consisting of two coupled molds having substantially-vertical coupled surfaces thereof which includes two positioning pins that can hang an upper edge side of the inner film on an upper edge portion of the mold surface of the mold, and upper and lower vacuum opening portions for film adsorption disposed so as to interpose the positioning pins therebetween from the upper and lower sides. The upper vacuum opening portion is formed in a line which extends along an upper edge of the mold surface.

### SUMMARY OF THE INVENTION

The present invention relate to a method for producing a molded part having a visually exposed surface comprising at least one side surface (for example one or two sides surfaces), the or each side surface being joined to a base surface at a corresponding substantially rectilinear edge, comprising:
(a) providing a mold comprising a mold surface complementary to said visually exposed surface;
(b) providing a film comprising a first face and a second face, and inserting said film into said mold such that said first face is facing said mold surface;
(c) closing the mold and injecting a molten material into the mold in a manner to urge said first face of said film into abutting contact with said mold surface and such that at least a layer of said molten material is formed in overlying relationship with said second face of said film;
(d) allowing the molten material to solidify and possess said film.

The method may be applied to the production of a molded part using a film that is a decorative film, which may be patterned in a natural-looking pattern, such as to provide a natural finish, or an artificial pattern or colors to provide any desired visual finish for the visually exposed surface. The mold surface may be comprised in a mold cavity, and step (c) may comprise injecting a molten plastic material into said cavity towards said second face. Step (c) includes injecting a molten material into the mold causing the film to conform to the mold surface by virtue of the molten material, when filling the mold cavity, exerting a force on the film forcing the film to abut intimately against the mold surface of the cavity in the part of the mold. Step (d) comprises allowing hardening of the molten material so as to form a hardened core having a face surface and at least one side surface that each meets the face surface of the hardened core at a corresponding edge. In some embodiments, step (b) comprises electrostatically holding at least a part of said film in abutting contact with said mold surface. According to the method of the invention, the cavity may comprise a plurality of at least one of projections and depressions in a desired pattern in at least a part of said mold surface. In some embodiments, the visually exposed surface may comprise a pair of spaced said side surfaces joined to said base surface at corresponding substantially rectilinear edges, and said mold surface comprises a mold base surface, mold side surfaces and mold edges substantially complementary to said side surfaces, edges and base surface, respectively, of said visually exposed surface. Optionally, the mold edges are substantially coplanar and parallel or diverging one with respect to another. Further optionally, the mold side surfaces may be of substantially equal depth one with respect to another. Typically, a parting line of said mold, defining the edge of said mold cavity, may be formed such as to comprise a free edge of each said mold side surface opposed to a corresponding said mold edge.

According to an aspect of the method of the invention, the film is provided having a film linear dimension orthogonal to said at least one rectilinear edge that is substantially greater than a corresponding projected linear dimension of said mold surface. For example, film linear dimension is between about 1% and about 10% greater than said projected linear dimension of said mold surface; or film linear dimension is between about 2% and about 5% greater than said projected linear dimension of said mold surface; or film linear dimension is between about 2.5% and about 3.5% greater than said projected linear dimension of said mold surface.

According to another aspect of the method of the invention, the film is provided having a thickness of between about 40 micron and about 80 micron. In other embodiments, the film thickness may be greater than about 80 micron, being up to or greater than about 160 micron. In yet other embodiments, the film thickness may be sufficiently thick for the film to be able to stand within the mold, when this is configured to receive the film in a generally vertical orientation.

According to another aspect of the method of the invention, a molded part is provided having a visually exposed surface comprising at least one side surface, the or each side surface being joined to a base surface at a corresponding substantially rectilinear edge, produced by the method of the invention, including any variation or embodiment thereof. In some embodiments, the molded part comprises a base part made from solidified said molten material comprising a base surface and a pair of side surfaces joined thereto along first and second edges, respectively, and further comprising a said film joined to said base part and in overlying and possessed relationship with said base part. In some embodiments, the first and second edges of the molded part are substantially rectilinear, coplanar and parallel one with respect to another; in other embodiments the edges may not be coplanar; in yet other embodiments the edges may be non-parallel, for example diverging. By way of example, the molded part may be configured as any one of a side of a cabinet, a door of a wardrobe, a door of a cabinet, a door of a room, a surface including a table or desk, and the like. In some embodiments, the film may comprise a thickness (prior to being processed to produce the molded part) of between about 40 micron and about 80 micron, and in other embodiments the film may be greater than about 80 micron, being up to or greater than about 160 micron. In yet other embodiments, the film thickness may be sufficiently thick for the film to be able to stand within the mold, when this is configured to receive the film in a generally vertical orientation. The molded part may be configured for any one or more of a variety of applications, for example the film may be in particular adapted for indoor applications, such as for example cabinet doors, sides, and so on, and provides a wood-like molded finish, or for outdoor applications or high scratch resistance applications. Optionally, the film may be multi-layered, comprising a base layer that faces and is possessed by said base part.

Optionally, the film may comprise an intermediate film layer onto which a desired pattern is printed. Optionally, the film may comprise a plurality of layers in laminated form. Optionally, the film comprises a film layer made from any one of: bi-oriented polypropylene (BOPP), extrusion direction oriented polypropylene (OPP), cast polypropylene (CCP); polyethylene-terephthalate (polyester) (PET), poly-methyl-met-acrylate (Acrylic) (PMMA), a metallic foil, and so on.

According to another aspect of the invention, a film is provided for use in an injection molding process, the film being adapted for being adhered to an injection molding material and for being possessed thereby when solidified, wherein said film comprises a thickness of less than about 80 microns.

According to another aspect of the invention, an injection molding process is provided comprising the step of injecting a molten material into a mold cavity comprising a film such as to abut the film against desired mold surfaces of said mold cavity by virtue of the molten material pressing against the mold cavity via said film, wherein said film comprises a thickness of between about 40 micron and about 80 micron.

According to another aspect of the invention, an apparatus is provided for producing a molded part having a visually exposed surface comprising at least one side surface, the or each side surface being joined to a base surface at a corresponding substantially rectilinear edge, comprising:
(a) a mold comprising a mold surface complementary to said visually exposed surface, and a mold cover;
(b) an inlet port connectable to a source of molten material; and
(c) a static electricity generating arrangement electrically coupled to said mold surface for holding at least a portion of said film in abutting contact with said mold surface.

Optionally, the mold surface is comprised in a cavity that further optionally comprises a plurality of at least one of projections and depressions in a desired pattern in at least a part of said mold surface. In some embodiments, the visually exposed surface comprises a pair of spaced said side surfaces joined to said base surface at corresponding substantially rectilinear edges, and said mold surface comprises a mold base surface, mold side surfaces and mold edges substantially complementary to said side surfaces, edges and base surface, respectively, of said visually exposed surface. Optionally, the mold edges are substantially coplanar and parallel or diverging one with respect to another. Optionally, the mold side surfaces are of substantially equal depth one with respect to another; alternatively the mold side surfaces are or different depths with respect to one another. A parting line of said mold, defining the edge of said mold cavity, may comprise a free edge of each said mold side surface opposed to a corresponding said mold edge; In particular, the mold may be configured such as to enable a molten material is injected into said mold cavity comprising a film such as to abut the film against said mold surfaces of said mold cavity by virtue of the molten material pressing against the mold cavity via said film,

According to another aspect of the invention, a system for producing or manufacturing a molded product or part is provided, based on the method according to the invention.

According to aspects of the present invention a method and apparatus are provided for making a part by injection molding, the part comprising a visually exposed face and at least one side surface, for example two spaced side surfaces. According to the invention, the visually-exposed face and side surfaces of the part are decorated in their entireties during the injection molding of the part.

A feature of the present invention is that the implementation of the method and use of the apparatus are relatively simple.

According to some embodiments or applications of the present invention a molded part may be manufactured having a superior finish and appearance than that of a molded part which does not have a film application, or a part that does have a film application that does not reach the full edge of the part. For example, a faux finish may be provided for an otherwise Olefin resin part.

Another feature of the invention is that recycled resins may be used without the disadvantage of color variations, as the film covers the visible surfaces.

Another feature of the present invention is that a molded part having a decorative visually exposed face according to the invention may be achieved in a generally more cost-effective manner than with other technologies in which the film is first thermoformed in a separate mold and then transferred to an injection mold, for example. Further, another feature of the invention is that it is possible to use some types films for example ultra thin films of thickness of between about 40 micron and about 80 micron, that would otherwise be difficult or impossible to use in an initial thermoforming step for shaping the film, where film thicknesses are typically greater than 80 micron.

The present invention provides according to one aspect a method for making a part by injection molding and decorating visually-exposed face and side surfaces of the part in their entireties during the injection molding of the part. The method includes the steps of providing a mold, inserting a decorative film into the mold, closing the mold, injecting a molten material into the mold causing the decorative film to conform to the mold by virtue of the molten material, when filling the mold, exerting a force on the decorative film forcing the decorative film to abut intimately against the mold, hardening the molten material so as to form a hardened core, and forming the part with the decorative film being adhered to the hardened core, by virtue of the decorative film being possessed by the hardened core when the molten material hardens and becomes the hardened core, so as to allow the decorative film to cover the hardened core and thereby eliminate a concern for color inconsistency of the hardened core caused by color variations of the molten material by virtue of the hardened core being covered by the decorative film.

The novel features which are considered characteristic of the present invention are set forth in the appended claims. The invention itself, however, both as to its construction and its method of operation, together with additional objects and advantages thereof, will be best understood from the following description of the invention when read and understood in connection with the accompanying drawings.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A-1D illustrate a process flow chart for carrying out the method of the present invention according to one aspect of the invention.

FIG. 2 illustrates, in isometric view, an example of a part manufactured according to a first embodiment the invention.

FIG. 3 illustrates, in transverse cross-sectional view, a mold for manufacturing the embodiment of FIG. 2.

FIG. 4 illustrates, in transverse cross-sectional view, a variation of the embodiment of FIG. 2.

FIG. 5(a) illustrates, in transverse cross-sectional view, the embodiment of FIG. 2, and

FIG. 5(b) illustrates, in transverse cross-sectional view, a dimension of the mold cavity of FIG. 3 in relation to a corresponding dimension of a corresponding film according to the invention.

FIG. 6 illustrates elements of a system according to the invention.

FIGS. 7(a) to 7(c) illustrate various embodiments of the film according to the invention.

FIG. 8 illustrates, in transverse cross sectional view, an example of a part manufactured according to a second embodiment the invention, in situ in a mold therefor.

FIG. 9 illustrates, in isometric view, an example of a part manufactured according to a third embodiment the invention.

### DETAILED DESCRIPTION OF EMBODIMENTS

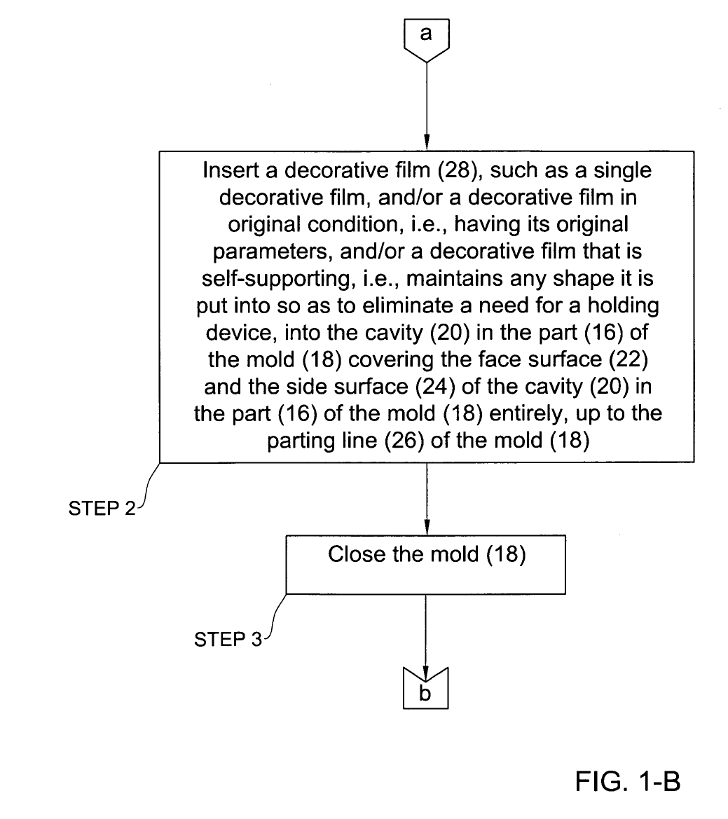

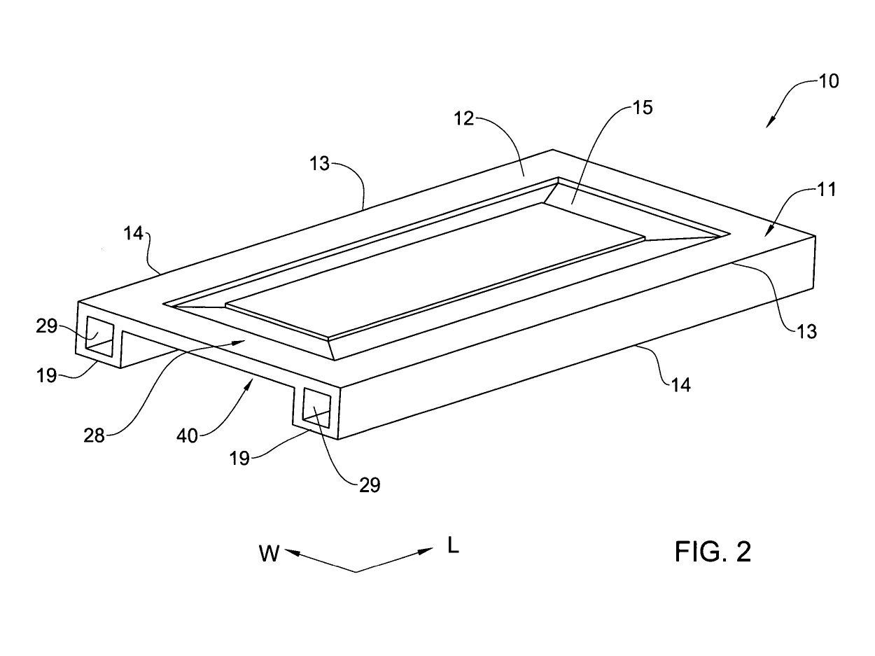

A first embodiment of an item of manufacture produced according to the invention, designated with the numeral 10 and referred to herein as a “part”, is illustrated in FIG. 2. The part 10 according to this embodiment is of general rectangular planform having a length dimension L and a width dimension W. The part 10 has a continuous visually exposed first surface 11 comprising a major visually exposed face comprising a visually exposed base surface 12, and two visually exposed side surfaces 14 aligned along the length direction L, generally orthogonal or at another generally acute or obtuse angle to base surface 12 at edges 13. The base surface 12 may be substantially planar or non-planar, and optionally may comprise decorative moldings or other three-dimensional features, such as depressions 15, and/or projections (not shown) which may serve, for example, to provide a particular three-dimensional appearance similar to that of a carved solid wood door panel, for example. The edges 13 are substantially rectilinear, substantially coplanar, and substantially parallel one with the other, and thus, other than the said decorative moldings or other three-dimensional features, the part 10 according to this embodiment may be considered to be generally two dimensional, having an approximately uniform transverse cross-section along the length dimension L, in particular the regions thereof close to the edges 13.

Where it is generally desired that the surface 11 have a particular surface finish or decorative pattern, this may be provided, according to the invention, by means of a film 28, which may be a decorative film. Thus, according to the invention, and referring to FIG. 5, a film 28 is formed on the visually exposed side surfaces 36 and base surface 34 of a basic molded part 31 to provide a desired visual finish on the visually exposed surfaces 12 and 14.

In the illustrated embodiment, the visually exposed side surfaces 36 on either side of the base surface 34 are of substantially equal depth along depth dimension D (FIG. 5), though in other variations of this embodiment the visually exposed side surfaces 36 may have different depths dimensions one from another.

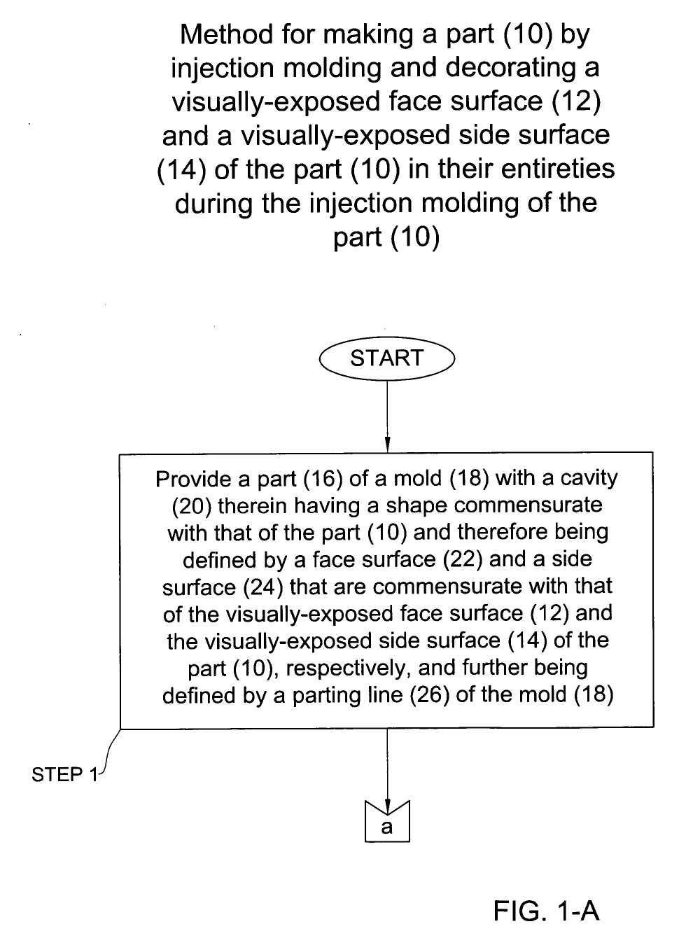

In the illustrated embodiment, the visually exposed side surfaces 36 on either side of the base surface 34 are of substantially equal length along depth dimension L (FIG. 1) and the edges 13 are substantially orthogonal to the end faces 47 of the item 10, providing a rectangular planform. In other variations of this embodiment, the visually exposed side surfaces 36 may have different length dimensions one from another, providing a trapezoidal planform rather than a rectangular planform. In yet other variations of this embodiment, the edges 13 are at an angle different from 90 degrees to the end faces 47 of the item 10, providing a planform in the form of a parallelogram rather than a rectangular planform. In the illustrated embodiment, the end faces 47 are substantially planar, though in other variations of this embodiment the end faces 47 may be non-planar, for example having a cylindrical contour or a three-dimensional contour, and so on.

By way of non-limiting examples, the part 10 may constitute the sides of a cabinet, the doors of a wardrobe or cabinet, a regular door, a surface such as a table or desk, and so on, all of which have at least one said first surface 11 that is in the main visually exposed.

By “visually exposed” with respect to a surface of a part is meant a surface of the part that may usually be seen from particular desired viewing directions when the part is in at least one intended position or location, or from the most common viewing direction for the part. For example, if the part is a table top, the visually exposed surface thereof may be the upper surface and sides of the table top, these being seen from the regular viewing directions, as opposed to the underside of the table top, which may only be seen from an uncommon viewing direction. Similarly, if the part is a wardrobe door, which is normally in the closed position, the visually exposed surface thereof may be the outer-facing surface and sides of the door, these being seen from the regular viewing directions, as opposed to the inner-facing side of the door, which may only be seen when the wardrobe door is in the open position or from inside the wardrobe.

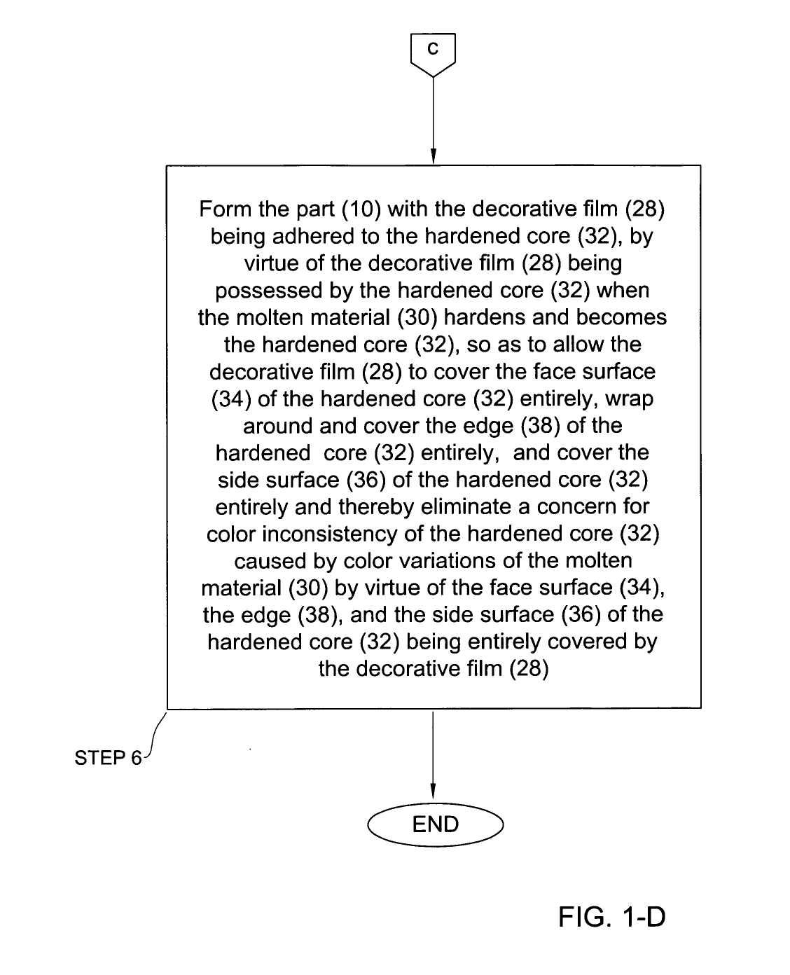

The part 10 also comprises a second surface 40, which is not typically or not intended to be visually exposed, at least most of the time or from the desired viewing angles of the visually exposed surfaces, and thus may constitute the inner-facing surfaces of a cabinet panel or door, the underside of a table, and so on. In the illustrated embodiment, the part 10 further comprises a pair of spaced hollow ribs 19, each having longitudinal cavity 29, of generally uniform and generally rectangular section, running along the longitudinal length of the part 10, wherein the side surfaces 14 are on one or another of said ribs 19. Optionally, and in other embodiments, for example as illustrated in FIG. 4, each hollow rib may be replaced with one or more spaced solid ribs 60, an outer part of the outermost rib thereof comprising said side surfaces 14. Referring to FIG. 4, in yet other embodiments, additionally and/or alternatively one or more inwardly lying hollow ribs 65 may be provided on the said second surface 40. In yet other embodiments of the invention, the part comprises only a single side wall along one longitudinal edge of the base surface, rather a pair of side walls, one at each longitudinal edge of the base surface.

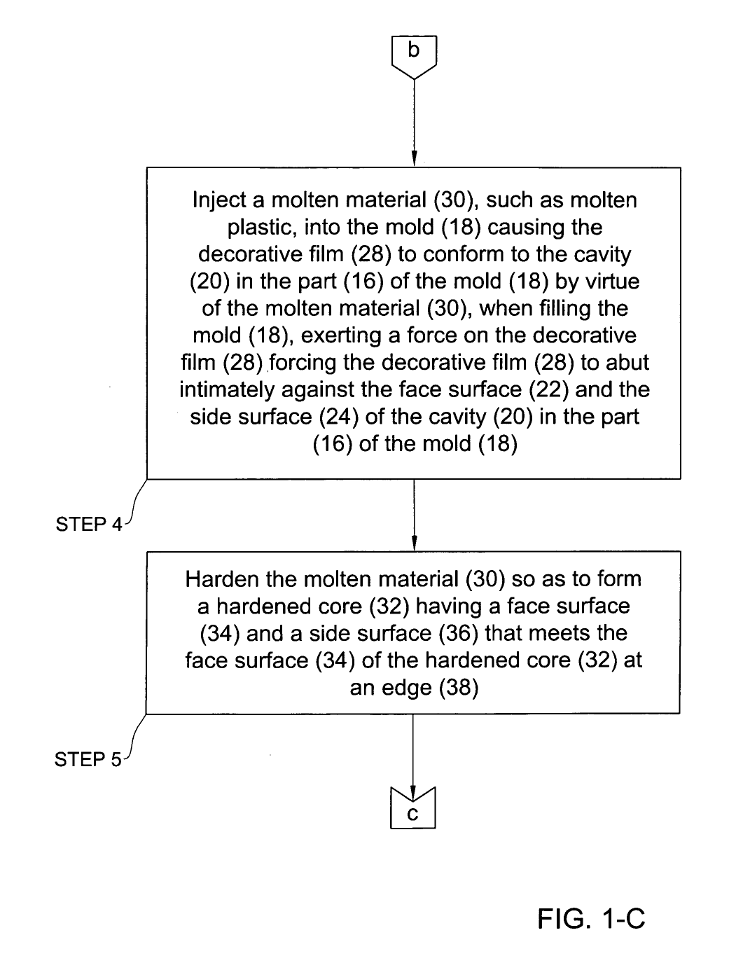

According to the invention, and referring to FIG. 3, a mold 18 is provided for producing the item 10. The mold 18 comprises a first mold part 16 and a second mold part 17 which may be reversibly joined together to provide a mold cavity 20 at least in the first mold part 16 in which the part 10 may be formed. The cavity 20 thus has a size substantially similar to, and a form or shape substantially complementary to, that of the item 10, taking into account factors such as springback, shrinkage and so on, as is known in the art. The part of the cavity 20 corresponding to the visually exposed surface 11 is defined by a face or base surface 22 (corresponding to base surface 12), joined to side surfaces 24 (corresponding to surfaces 14) at concave edges 23 (corresponding to edges 13), the side surfaces 24 terminating at free edges 27, which are associated with the parting line 26 of mold 18, where the first and second mold parts join together. The second mold part 17 comprises a mating portion 17′, adapted for mating with mating portion 16′ of the first mold part 16 at the parting line 26. The second mold part 17 also comprises an inner-facing surface 42, substantially complementary to the unexposed surface 40, and further comprises at least one injection station 45, for example at the geometric center of the surface 42, providing fluid communication between cavity 20 and an injection material source (not shown), at least when the mold 18 is closed and ready for use. The mold 18 further comprises a pair of retractable columns 25 having a cross-sectional profile complementary to the desired cross-section of the cavities 29.

Referring to FIG. 5(b), the fully projected linear width dimension W_{f} of the film 28 (when flat), i.e. in a direction substantially orthogonal to the edges 38, may be slightly larger than the corresponding projected dimension Wₚ of the U-shaped periphery of the surface 11, i.e., the scalar sum of the widths of the base surface 12 and of the two side surfaces 14. In some applications of the invention, the ratio of W_{f}/Wₚ may be in the range of between about 1.02 and about 1.05, for example, in some cases the ratio being about 1.025 or about 1.035, for example. Accordingly, when the film 28 is inserted and held in the mold part 16 such that the edges of the free ends 28A, 28B of the film are aligned with the parting line 26, the film 28 is not lying perfectly flat against walls 22, 24 of the mold part 16. During operation of the mold 18, as the base material is injected via opening 30 and spreads through cavity 20, the additional width dimension of the film enables the same to assume the full U-shaped profile of walls 22, 24 of the mold part 16 without the film cracking or splitting at the edges 13 of the part. Furthermore, the reduced thickness of the film, and the materials from which the film 28 is made, are such as to enable the same to stretch during the injection process to assume any suitable desired shape of the mold 18 without cracking or breaking.

When the part 10 is finished, and the injection material has hardened, the columns 25 are retracted out of the cavity 20, and the mold 18 may be opened and the part 10 removed therefrom.

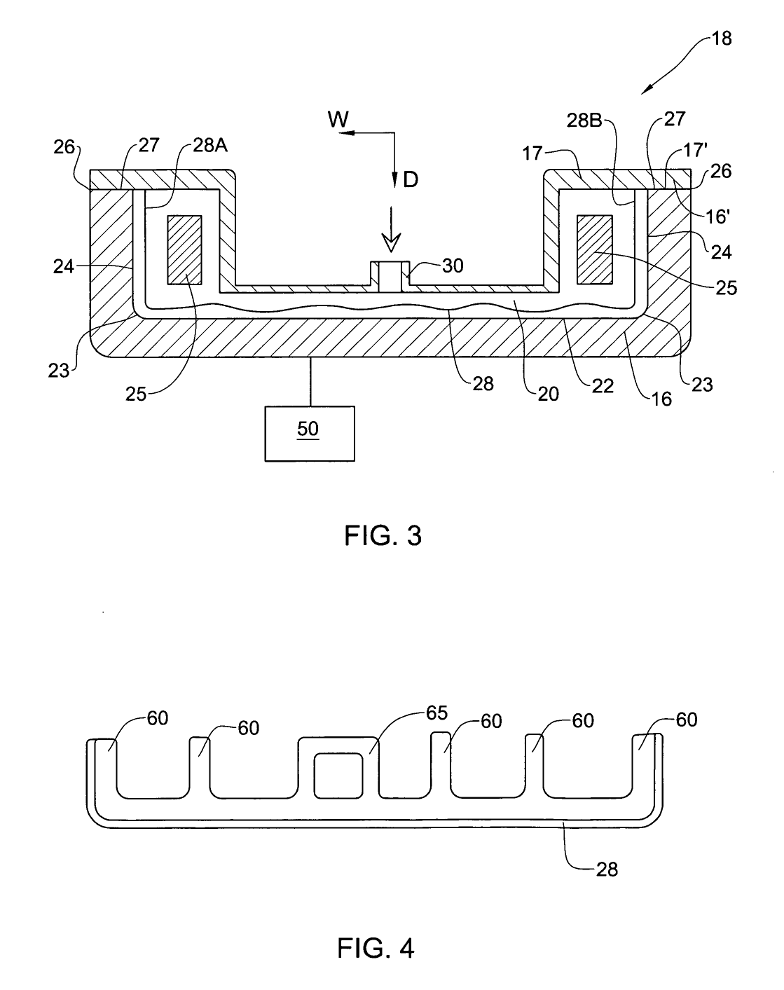

According to another aspect of the invention, and referring to FIG. 6, the mold 18 may be comprised in a manufacturing system, generally designated 100, which may optionally further comprise one or more of the following: a supply 110 of film 28; a cutting station 120; a film handling arrangement 130; output arrangement 140; a supply 150 of suitable injection molding material.

The film supply 110 may comprise a roll of film or predetermined width generally correlated with the length or width dimension of first surface 11. The roll may be freely mounted for rotation on a suitable cradle, or may be operatively connected to a motor, for example, to unroll a particular length of film onto the cutting station 120.

The cutting station 120 is adapted for cutting a predetermined length of film 28, correlated with the other one of the length or width dimension of first surface 11, and may comprise any suitable holding arrangement for holding the film in place while it is being cut, using any cutting arrangement as is known in the art.

The film handling arrangement 130 is adapted for taking the cut film 28 from the cutting station 120, and for transferring the film into the cavity 20 of mold 18, when the mold halves 16, 17 are separated, and thus may comprise a suitable mechanism for grasping the film and manipulating the same into the cavity. When the film is in position in the cavity, a suitable electrostatic charge may be applied to the mold half 16, by means of a suitable static electricity generating mechanism 50 electrically coupled to the mold half 16 (FIG. 3), so as to attract and retain the film in place over the surfaces 22 and 24 of the mold, such that at least a part of the film is in abutting contact with the mold surface. Subsequently thereto, the handling arrangement 130 can be removed, and enable the second mold half 17 to be closed onto the first mold half 16.

Alternatively, for example, the cutting station may be replaced with a stack of films 28, and the film handling arrangement 130 comprises a suitable mechanism for delivering one film at a time to the mold.

The supply 150 of suitable injection molding material is in fluid communication with port 30 via suitable valves (not shown), and enables a suitable quantity of flowable material, for example a molten plastics or polymeric material, to be selectively injected into mold 18 during operation of the system 100.

The output arrangement 140 is adapted for extracting the part 10 from the mold after the part 10 has been solidified therein, and for transporting the part 10 to a post-processing facility (not shown) for inspection, quality control, packaging and so on.

Thus, and referring now to FIGS. 1A-1D, which illustrate a process flow chart for carrying out the method of the present invention according to some aspect thereof, and in which like numerals indicate like parts, the method for making a part 10 by injection molding and decorating a visually-exposed face surface 12 and a visually-exposed side surface 14 of the part 10 in their entireties during the injection molding of the part 10, according to an embodiment of the invention, comprises the steps of:

STEP 1: Providing a mold part 16 of a mold 18 with a cavity 20 therein, as disclosed herein for example, the cavity 20 having a shape commensurate with that of the part 10 and therefore being defined by a face surface 22 and a side surface 24 that are commensurate with that of the visually-exposed face surface 12 and the visually-exposed side surface 14 of the part 10, respectively, and further being defined by a parting line 26 of the mold 18.

STEP 2: Inserting a decorative film 28, into the cavity 20 in the part 16 of the mold 18 covering the face surface 22 and the side surface 24 of the cavity 20 in the part 16 of the mold 18, up to the parting line 26 of the mold 18.

STEP 3: Closing the mold 18 by bringing the mating parts 16′ and 17′ of the mold parts 16, 17, respectively, together.

STEP 4: Injecting a molten material 30, such as molten plastic, into the mold 18 causing the decorative film 28 to conform to the cavity 20 in the part 16 of the mold 18 by virtue of the molten material 30, when filling the mold 18, exerting a force on the decorative film 28 forcing the decorative film 28 to abut intimately against the face surface 22 and the side surface 24 of the cavity 20 in the part 16 of the mold 18.

STEP 5: Allowing the molten material to harden 30 so as to form a hardened core 32 having a face surface 34 and a side surface 36 that meets the face surface 34 of the hardened core 32 at an edge 38.

STEP 6: Forming the part 10 with the decorative film 28 being adhered to the hardened core 32, by virtue of the decorative film 28 being possessed by the hardened core 32 when the molten material 30 hardens and becomes the hardened core 32, so as to allow the decorative film 28 to cover the face surface 34 of the hardened core 32 entirely, wrap around and cover the edge 38 of the hardened core 32 entirely, and cover the side surface 36 of the hardened core 32 entirely and thereby eliminate a concern for color inconsistency of the hardened core 32 caused by color variations of the molten material 30 by virtue of the face surface 34, the edge 38, and the side surface 36 of the hardened core 32 being entirely covered by the decorative film 28.

Thus, according to an aspect of the invention, a decorative film 28 is formed on the visually exposed side surfaces 36 and base surface 34 of a basic molded part 31 in a mold 18 as the material thereof hardens in the mold 18, thereby creating part 10 with the film 28 integrally formed therewith. The film 28 may be a single decorative film, and/or a decorative film in original condition, i.e., having its original parameters. The film 28 may be held in position within the mold by means of the film handling arrangement 130 and the subsequent electrostatic attraction, and/or the decorative film may be self-supporting, i.e., maintains any shape it is put into so as to eliminate a need for a holding device.

The film 28 may be formed as a single layer of material of suitable color, pattern, shape, and so on. Alternatively, the film 28 may be formed as a laminate of various layers, for example as follows.

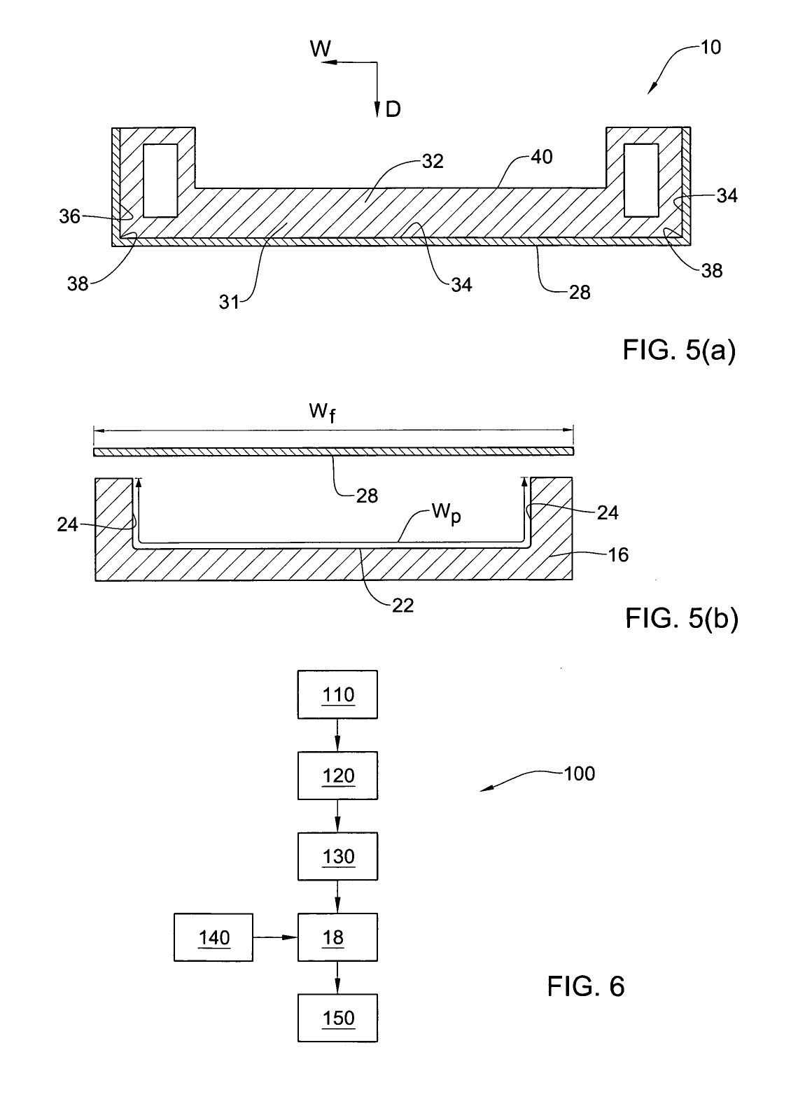

Referring to FIG. 7(a), a first embodiment of the film, designated 28A, is particular adapted for indoor applications, such as for example cabinet doors, sides, and so on, and provides a wood-like molded finish. The film 28A comprises a base layer 206 that faces the exposed side surfaces 36 and base surface 34 of a basic molded part in a mold 18 as the material thereof hardens in the mold 18. The base layer 206 has an upper surface thereof that is activated by any suitable method, for example a plasma, corona, flame or chemical treatment, to produce treated layer 205. An upper layer 201 comprises at the lower side thereof a lower surface that is also subjected to a corona treatment to produce treated layer 202. A suitable pattern 203 may be printed onto layer 202, which is then is laminated onto base layer 206 via an intermediate adhesive layer 204, in any suitable manner. The printed pattern may give the appearance of any desired wood finish, for example. Further by way of example: the film 28A may be up to about 100 micron thick; the base layer 206 and the upper layer 201 may each be made from any one of bi-oriented polypropylene (BOPP), for example about 20 to about 30 micron thick, or from extrusion direction oriented polypropylene (OPP), for example about 20 to about 30 micron thick, or from cast polypropylene (CCP), for example about 30 to about 60 micron thick.

Referring to FIG. 7(b), a second embodiment of the film, designated 28B, is particular adapted for indoor applications, and also for high scratch resistance applications, such as for example cabinet doors, sides, and so on, and provides a wood-like molded finish. The film 28B comprises a base layer 216 that faces the exposed side surfaces 36 and base surface 34 of a basic molded part in a mold 18 as the material thereof hardens in the mold 18. The base layer 216 has an upper surface thereof that is activated by any suitable method, for example a plasma, corona, flame or chemical treatment, to produce treated layer 215. An upper scratch resistant layer 211 comprises at the lower side thereof a pattern 213 printed thereon, and the layer 211 is then is laminated onto base layer 216 via an intermediate adhesive layer 214, in any suitable manner. The printed pattern may give the appearance of any desired wood finish, for example. Further by way of example: the film 28B may be up to about 100 micron thick; the base layer 216 may be made from any one of bi-oriented polypropylene (BOPP), for example about 20 to about 30 micron thick, or from extrusion direction oriented polypropylene (OPP), for example about 20 to about 30 micron thick, or from cast polypropylene (CCP), for example about 30 to about 60 micron thick; the upper layer 211 may be made from polyethylene-terephthalate (polyester) (PET), for example about 10 to about 30 micron thick. In an alternative embodiment adapted for outdoor uses, the film 28B may be up to 150 micron thick, and the upper layer 211 may be made from poly-methyl-met-acrylate (Acrylic) (PMMA), for example about 60 to about 70 micron thick, rather than from PET.

Referring to FIG. 7(c), a third embodiment of the film, designated 28C, is particular adapted for indoor applications, and also for high scratch resistance applications, and provides a metallic finish.

The film 28C comprises a base layer 226 that faces the exposed side surfaces 36 and base surface 34 of a basic molded part in a mold 18 as the material thereof hardens in the mold 18. The base layer 226 has an upper surface thereof that is activated by any suitable method, for example a plasma, corona, flame or chemical treatment, to produce treated layer 225. An upper scratch resistant layer 221 comprises at the lower side thereof a lower surface that is also subjected to a corona treatment to produce treated layer 222. The film 28C further comprises a metallic foil 224, for example an aluminium foil, of thickness between about 5 micron to about 15 micron for example, which is then laminated between base layer 226 and upper layer 221 via intermediate adhesive layers 223, 227, respectively, in any suitable manner. Thus, by way of example: the film 28C may be up to about 100 micron thick; the base layer 226 may be made from any one of bi-oriented polypropylene (BOPP), for example about 20 to about 30 micron thick, or from extrusion direction oriented polypropylene (OPP), for example about 20 to about 30 micron thick, or from cast polypropylene (CCP), for example about 30 to about 60 micron thick; the upper layer 221 may be made from polyethylene-terephthalate (polyester) (PET), for example about 10 to about 30 micron thick. In an alternative embodiment adapted for outdoor uses, the film 28C may be up to 150 micron thick, and the upper layer 221 may be made from poly-methyl-met-acrylate (Acrylic) (PMMA), for example about 60 to about 70 micron thick, rather than from PET.

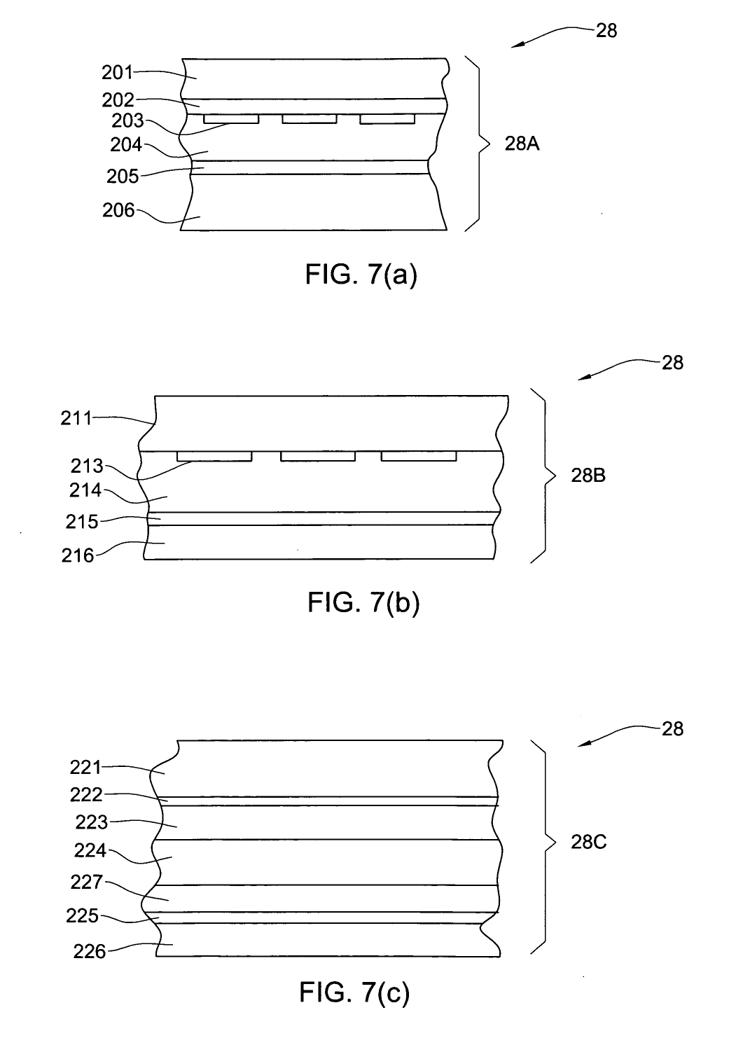

Referring to FIG. 8, a second embodiment of an item of manufacture produced according to the invention, the part, designated herein as 310, comprises the same features as described herein for the first embodiment, mutatis mutandis, with the major difference that rather than having two visually exposed side surfaces, the part 310 has a decorative film 328 formed over a single visually exposed side surface 336, edge 338 and a visually exposed base surface 334 of the basic molded part 331. The corresponding mold 318, and other parts of the corresponding manufacturing system, are similar to mold 18 and system 100 as described herein, mutatis mutandis.

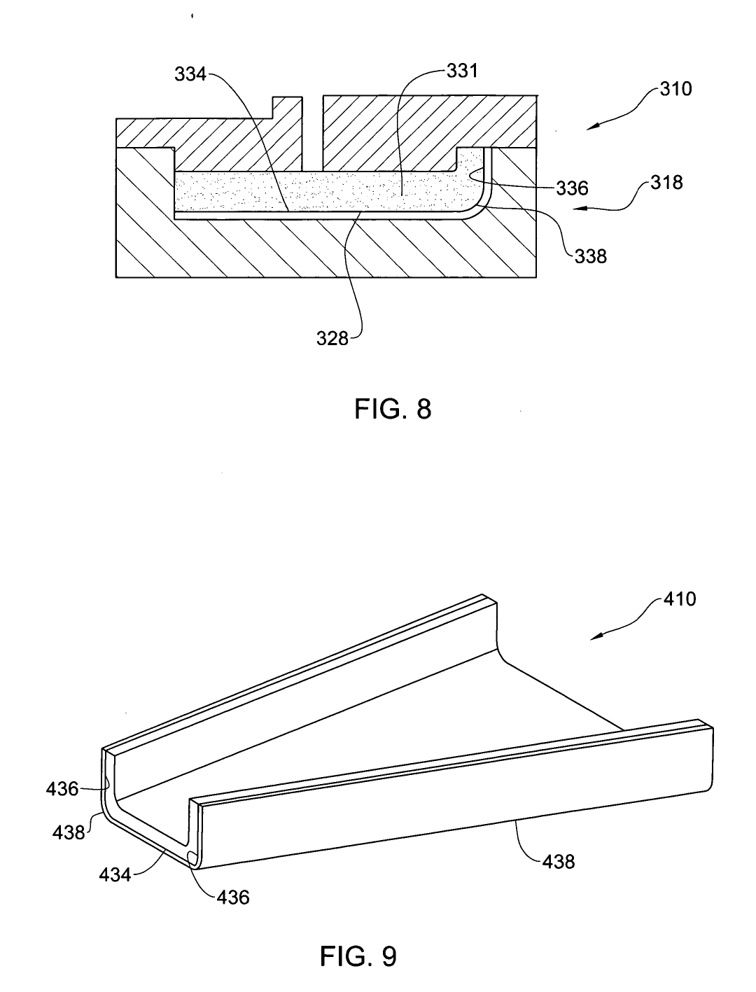

Referring to FIG. 9, a third embodiment of an item of manufacture produced according to the invention, the part, designated herein as 410, comprises the same features as described herein for the first embodiment, mutatis mutandis, with the major difference that rather than having the two edges between the visually exposed side surfaces and the base surface parallel one with respect to the other, the part 410 has a decorative film 428 formed over two visually exposed side surface 436, edges 438 and a visually exposed base surface 434 of the basic molded part 431, wherein the edges 438 are non parallel with respect to one another, and diverge or converge with respect to one another. The corresponding mold, and other parts of the corresponding manufacturing system, are similar to mold 18 and system 100 as described herein, mutatis mutandis.

According to other aspects of the invention, the invention relates to a method and apparatus for making a part by injection molding and decorating a visually-exposed face surface and a visually-exposed side surface of the part in their entireties during the injection molding of the part. The method includes the steps of providing a mold, inserting a decorative film into the mold, closing the mold, injecting a molten material into the mold causing the decorative film to conform to the mold by virtue of the molten material, when filling the mold, exerting a force on the decorative film forcing the decorative film to abut intimately against the mold, hardening the molten material so as to form a hardened core, and forming the part with the decorative film being adhered to the hardened core, by virtue of the decorative film being possessed by the hardened core when the molten material hardens and becomes the hardened core, so as to allow the decorative film to cover the hardened core and thereby eliminate a concern for color inconsistency of the hardened core caused by color variations of the molten material by virtue of the hardened core being covered by the decorative film.

It will be understood that each of the elements described above, or two or more together, may also find a useful application in other types of constructions differing from the types described above.

Other aspects of the invention described herein are set out in the following numbered clauses:

1. A method for making a part by injection molding and decorating a visually-exposed face surface and at least one visually-exposed side surface of the part in their entireties during the injection molding of the part, said method comprising the steps of:
a) providing a mold;
b) inserting a decorative film into the mold;
c) closing the mold;
d) injecting a molten material into the mold causing the decorative film to conform to the mold by virtue of the molten material, when filling the mold, exerting a force on the decorative film forcing the decorative film to abut intimately against the mold;
e) hardening the molten material so as to form a hardened core; and
f) forming the part with the decorative film being adhered to the hardened core, by virtue of the decorative film being possessed by the hardened core when the molten material hardens and becomes the hardened core, so as to allow the decorative film to cover the hardened core and thereby eliminate a concern for color inconsistency of the hardened core caused by color variations of the molten material by virtue of the hardened core being covered by the decorative film.

2. The method as defined in numbered clause 1, wherein said providing step includes providing a part of a mold with a cavity therein.

3. The method as a defined in numbered clause 2, wherein said providing step includes providing a part of a mold with a cavity therein having a shape commensurate with that of the part and therefore being defined by a face surface and a side surface that are commensurate with that of the visually-exposed face surface and the visually-exposed side surface of the part, respectively, and further being defined by a parting line of the mold.

4. The method as defined in numbered clause 3, wherein said inserting step includes inserting a decorative film into the cavity in the part of the mold covering the top surface and the side surface of the cavity in the part of the mold entirely, up to the parting line of the mold.

5. The method as defined in numbered clause 1, wherein said injecting step includes injecting molten plastic into the mold.

6. The method as defined in numbered clause 3, wherein said injecting step includes injecting a molten material into the mold causing the decorative film to conform to the cavity in the part of the mold by virtue of the molten material, when filling the mold, exerting a force on the decorative film forcing the decorative film to abut intimately against the face surface and the side surface of the cavity in the part of the mold.

7. The method as defined in numbered clause 1, wherein said hardening step includes hardening the molten material so as to form a hardened core having a face surface and a side surface that meets the face surface of the hardened core at an edge.

8. The method as defined in numbered clause 7, wherein said forming step includes forming the part with the decorative film being adhered to the hardened core, by virtue of the decorative film being possessed by the hardened core when the molten material hardens and becomes the hardened core, so as to allow the decorative film to cover the face surface of the hardened core entirely, wrap around and cover the edge of the hardened core entirely, and cover the side surface of the hardened core entirely and thereby eliminate a concern for color inconsistency of the hardened core caused by color variations of the molten material by virtue of the face surface, the edge, and the side surface of the hardened core being entirely covered by the decorative film.

9. The method as defined in numbered clause 1, wherein said inserting step includes inserting a single decorative film into the mold.

10. The method as defined in numbered clause 1, wherein said inserting step includes inserting a decorative film in original condition into the mold.

11. The method as defined in numbered clause 1, wherein said inserting step includes inserting a decorative film that is self-supporting so as to eliminate a need for a holding device into the mold.

While the invention has been illustrated and described as embodied in a method for making a part by injection molding and decorating visually-exposed face and side surfaces of the part in their entireties during the injection molding of the part, however, it is not limited to the details shown, since it will be understood that various omissions, modifications, substitutions, and changes in the forms and details of the device illustrated and its operation can be made by those skilled in the art without departing in any way from the spirit of the present invention.

Without further analysis the foregoing will so fully reveal the gist of the present invention that others can by applying current knowledge readily adapt it for various applications without omitting features that from the standpoint of prior art fairly constitute characteristics of the generic or specific aspects of the invention.

1. A method for producing a molded part having a visually exposed surface comprising at least one side surface, the or each side surface being joined to a base surface at a corresponding substantially rectilinear edge, comprising:
(a) providing a mold comprising a mold surface complementary to said visually exposed surface;
(b) providing a film comprising a first face and a second face, and inserting said film into said mold such that said first face is facing said mold surface;
(c) closing the mold and injecting a molten material into the mold in a manner to urge said first face of said film into abutting contact with said mold surface and such that at least a layer of said molten material is formed in overlying relationship with said second face of said film;
(d) allowing the molten material to solidify and possess said film.

2. The method according to claim 1, wherein said film is a decorative film.

3. The method according to claim 1, wherein said mold surface is comprised in a mold cavity, and step (c) comprises injecting a molten plastic material into said cavity towards said second face.

4. The method according to claim 3, wherein step (c) includes injecting a molten material into the mold causing the film to conform to the mold surface by virtue of the molten material, when filling the mold cavity, exerting a force on the film forcing the film to abut intimately against the mold surface of the cavity in the part of the mold.

5. The method according to claim 1, wherein step (d) comprises allowing hardening of the molten material so as to form a hardened core having a face surface and at least one side surface that each meets the face surface of the hardened core at a corresponding edge.

6. The method according to claim 1, wherein step (b) comprises electrostatically holding at least a part of said film in abutting contact with said mold surface.

7. The method according to claim 3, wherein said cavity comprises a plurality of at least one of projections and depressions in a desired pattern in at least a part of said mold surface.

8. The method according to claim 1, wherein said visually exposed surface comprises a pair of spaced said side surfaces joined to said base surface at corresponding substantially rectilinear edges, and said mold surface comprises a mold base surface, mold side surfaces and mold edges substantially complementary to said side surfaces, edges and base surface, respectively, of said visually exposed surface.

9. The method according to claim 1, wherein said film is provided having a film linear dimension orthogonal to said at least one rectilinear edge that is substantially greater than a corresponding projected linear dimension of said mold surface.

10. The method according to claim 9, wherein said film linear dimension is between about 2% and about 5% greater than said projected linear dimension of said mold surface.

11. The method according to claim 1, wherein said film comprises a thickness of between about 40 micron and about 80 micron.

12. A molded part having a visually exposed surface comprising at least one side surface, the or each side surface being joined to a base surface at a corresponding substantially rectilinear edge, produced by the method of claim 1.

13. A molded part according to claim 12, wherein said molded part comprises a base part made from solidified said molten material comprising a base surface and a pair of side surfaces joined thereto along first and second edges, respectively, and further comprising a said film joined to said base part and in overlying and possessed relationship with said base part.

14. A molded part according to claim 13, wherein said first and second edges are substantially coplanar and parallel one with respect to another.

15. A molded part according to claim 13, wherein said molded part is configured as any one of a side of a cabinet, a door of a wardrobe, a door of a cabinet, a door of a room, a surface including a table or desk, and the like.

16. A molded part according to claim 13, wherein said base part is made from a suitable plastic material.

17. A molded part according to claim 13, wherein said film comprises a thickness of between about 40 micron and about 80 micron.

18. A molded part according to claim 13, wherein said film comprises a thickness of greater than about 80 micron.

19. A molded part according to claim 13, wherein said film is adapted for at least one of indoor applications, outdoor applications and high scratch resistance applications.

20. A molded part according to claim 13, wherein said film is multi-layered, comprising a base layer that faces and is possessed by said base part.

21. A molded part according to claim 20, wherein said film comprises an intermediate film layer onto which a desired pattern is printed.

22. A molded part according to claim 20, wherein said film comprises a plurality of layers in laminated form.

23. A molded part according to claim 20, wherein said film comprises a film layer made from any one of: bi-oriented polypropylene (BOPP), extrusion direction oriented polypropylene (OPP), cast polypropylene (CCP); polyethylene-terephthalate (polyester) (PET), poly-methyl-met-acrylate (Acrylic) (PMMA), a metallic foil.

24. A film for use in an injection molding process, the film being adapted for being adhered to an injection molding material and for being possessed thereby when solidified, wherein said film comprises a thickness of less than about 80 microns

25. An injection molding process comprising the step of injecting a molten material into a mold cavity comprising a film such as to abut the film against desired mold surfaces of said mold cavity by virtue of the molten material pressing against the mold cavity via said film, wherein said film comprises a thickness of between about 40 micron and about 80 micron.

26. Apparatus for producing a molded part having a visually exposed surface comprising at least one side surface, the or each side surface being joined to a base surface at a corresponding substantially rectilinear edge, comprising:
(a) a mold comprising a mold surface complementary to said visually exposed surface, and a mold cover;
(b) an inlet port connectable to a source of molten material; and
(c) a static electricity generating arrangement electrically coupled to said mold surface for holding at least a portion of said film in abutting contact with said mold surface.

27. Apparatus according to claim 26, wherein said cavity comprises a plurality of at least one of projections and depressions in a desired pattern in at least a part of said mold surface.

28. Apparatus according to claim 26, wherein said visually exposed surface comprises a pair of spaced said side surfaces joined to said base surface at corresponding substantially rectilinear edges, and said mold surface comprises a mold base surface, mold side surfaces and mold edges substantially complementary to said side surfaces, edges and base surface, respectively, of said visually exposed surface.

29. Apparatus according to claim 28, wherein said mold edges are substantially coplanar and parallel or diverging one with respect to another.

30. Apparatus according to claim 28, wherein said mold side surfaces are of substantially equal depth one with respect to another.

31. Apparatus according to claim 28, wherein a parting line of said mold, defining the edge of said mold cavity, comprises a free edge of each said mold side surface opposed to a corresponding said mold edge.

32. Apparatus according to claim 26, wherein said mold is configured such as to enable a molten material is injected into said mold cavity comprising a film such as to abut the film against said mold surfaces of said mold cavity by virtue of the molten material pressing against the mold cavity via said film,
